(19) United States
(12) Patent Application Publication
(10) Pub. No.: US 2010/0318941 A1
(43) Pub. Date: Dec. 16, 2010

(54) ELECTRONIC DEVICE

(76) Inventors: Akira Yamada, Osaka (JP); Suguru Takamatsu, Osaka (JP); Yoko Akiba, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/864,672

(22) PCT Filed: Jan. 28, 2009
(86) PCT No.: PCT/JP2009/000318

§ 371 Date: Jul. 27, 2010

(30) Foreign Application Priority Data
Jan. 28, 2008 (JP) 2008-016120

(51) Int. Cl. G06F 3/048

(52) U.S. Cl. 715/835

(57) ABSTRACT

A user-friendly electronic device is provided by getting icons shown on a display section.

An electronic device according to the present invention is designed to operate adaptively according to a combination of settings of a plurality of options that are offered in order to allow the user to select his or her desired mode of operation. The device includes: an interface section to be manipulated by the user to change the settings; a display section that not only shows a number of icons symbolizing the plurality of options but also displays information about a currently exercised option represented by a chosen one of the icons; and a control section for controlling the display operation of the display section such that if the user has entered an instruction to change the settings of the currently exercised option through the interface section, information about the currently exercised option stops being displayed.

### TECHNICAL FIELD

The present invention relates to an electronic device that can have its mode of operation controlled by the user by changing its settings. More particularly, the present invention relates to an electronic device that can have its mode of operation controlled by getting multiple icons, symbolizing a number of different options, shown on a display device and allowing the user to change the settings according to his or her preference.

### BACKGROUND ART

Recently, a lot of electronic devices with a dot-matrix-addressed display device have been put on the market one after another. Many of them allow the user to change their modes of operation by presenting options and settings on the display device. Under the circumstances such as these, there is an increasing demand for electronic devices that will come in even handier for the user who is going to change the modes of operation and settings.

Patent Document No. 1 discloses an electronic camera including an LCD monitor. On the rear side of the camera, arranged are cross keys, the LCD monitor and so on. The LCD monitor displays not only an image captured or played back but also menu balloons for making various settings about the electronic camera on an OSD (on screen display). In such an electronic camera, the user selects one of the menu options he or she likes and changes the settings by tapping the cross keys. Thus, he or she can enter various settings even though there are only a few keys. By combining those cross keys with the LCD monitor in this manner, an electronic camera that is relatively easy to handle is provided.

Patent Document No. 1: Japanese Patent Application Laid-Open Publication No. 2001-211368

### DISCLOSURE OF INVENTION

### Problems to be Solved by the Invention

However, the menu balloons presented on the LCD monitor simply symbolize each mode of operation or setting, and therefore, sometimes it is difficult to understand what the menu balloon means by itself.

It is therefore an object of the present invention to provide a user-friendly electronic device by clearly showing the specifics of each mode of operation or setting to the user and by simplifying the layout of a dialog box on the screen as much as possible.

### Means for Solving the Problems

An electronic device according to the present invention is designed to operate adaptively according to a combination of settings of a plurality of options that are offered in order to allow the user to select his or her desired mode of operation. The device includes: an interface section to be manipulated by the user to change the settings; a display section that not only shows a number of icons symbolizing the plurality of options but also displays information about a currently exercised option represented by a chosen one of the icons; and a control section configured to control the display operation of the display section such that if the user has entered an instruction to change the settings of the currently exercised option through the interface section, information about the currently exercised option stops being displayed.

The display section may display the information about the currently exercised option and information about a setting that is presently adopted with respect to the currently exercised option until the instruction to change the settings of the currently exercised option is entered through the interface section.

The display section may show an icon representing each of a plurality of settings available with respect to the currently exercised option. When the instruction to change the settings of the currently exercised option is entered through the interface section, the control section may change what is presented on the display section so that information about a newly adopted setting represented by the icon now chosen is provided.

The display section may show a plurality of icons, representing the plurality of settings available with respect to the currently exercised option, at the same time.

As for any of the options, of which the settings are currently unchangeable, the display section may show an icon, representing a setting that is presently adopted, with respect to that option.

The display section may provide a brief description of a function of the electronic device as information about the currently exercised option, and may also indicate, as information about the presently adopted setting, whether the function is now ON or OFF and/or a required minimum level to perform the function.

The interface section may accept an instruction to change the settings of the currently exercised option and an instruction to choose one of the icons symbolizing the plurality of options that have been entered in mutually different ways.

### Effects of the Invention

According to the present invention, information about a currently exercised option, symbolized by a currently chosen icon, is displayed on the display section, thus providing an operation mode setting environment that is more easily understandable for any user. That is to say, the user can understand more easily what the icon means, and can handle the electronic device smoothly. On top of that, as soon as the electronic device is manipulated to change the settings of the currently exercised option, information about the currently exercised option stops being displayed immediately. As a result, the dialog box on the screen can be simplified and the chances of wrong handling can be reduced. Consequently, an electronic device that is far easier to use for any user is provided.

### BRIEF DESCRIPTION OF DRAWINGS

FIG. 1 is a block diagram illustrating a configuration for a digital camera 100 as a preferred embodiment of the present invention.

FIG. 2 is a rear view of the digital camera 100.

FIG. 3 illustrates what is presented on the LCD monitor 170 when the RIGHT key 183 is pressed down after the quick menu has been called up onto the screen under the control of the controller 150.

FIG. 4 illustrates how the quick menu looks with only the setting information display field D90 staying put in response to the pressure on either the UP key 182 or the DOWN key 184 in the state shown in FIG. 3.

FIG. 5 illustrates an exemplary quick menu image to be displayed in a situation where the settings of an operation mode option called “LCD screen brightness” are ready to change in response to the pressure on the RIGHT key 183 or the LEFT key 185.

FIG. 6 is a state transition diagram illustrating how this digital camera 100 operates.

### DESCRIPTION OF REFERENCE NUMERALS

100 digital camera
120 optical system
121 CCD image sensor
122 A/D converter
130 image processing section
140 buffer memory
141 flash memory
150 controller
160 card slot
161 memory card
170 LCD monitor
180 interface section

### BEST MODE FOR CARRYING OUT THE INVENTION

Hereinafter, a digital camera will be described as a specific preferred embodiment of an electronic device according to the present invention with reference to the accompanying drawings.

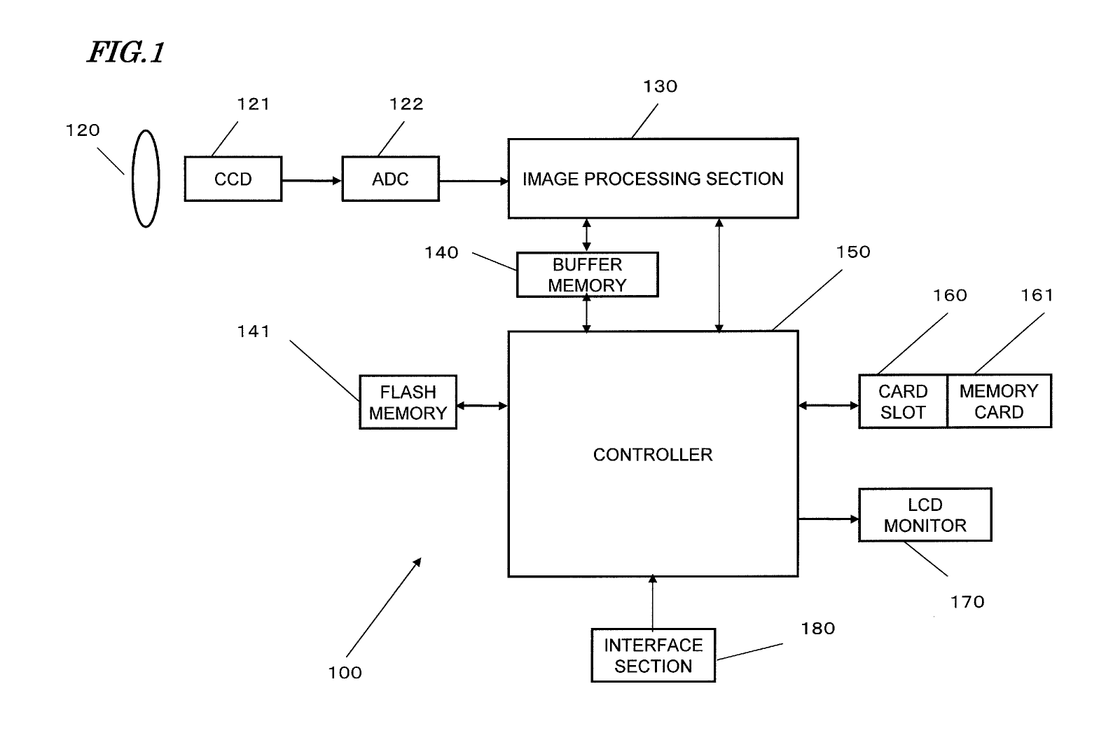

FIG. 1 is a block diagram illustrating a configuration for a digital camera 100 as a preferred embodiment of the present invention.

The digital camera 100 includes an optical system 120, a CCD image sensor 121, an A/D converter (ADC) 122, an image processing section 130, a buffer memory 140, a flash memory 141, a controller 150, a card slot 160 to be loaded with a memory card 161, an LCD monitor 170 and an interface section 180.

The optical system 120 condenses the light that has been reflected from a subject, thereby producing a subject's image on the CCD image sensor 121. The optical system 120 may be made up of lenses. However, the group of lenses included in the optical system 120 may consist of any number of lenses.

The CDD image sensor 121 is an imager that captures the subject's image and generates image data. Although the CCD image sensor 121 is used in this preferred embodiment, any other imager such as a CMOS image sensor or an NMOS image sensor may also be used according to the present invention.

The A/D converter 122 converts the analog image data that has been generated by the CCD image sensor 121 into digital one.

The image processing section 130 subjects the image data to various types of image processing, which include, but are not limited to, gamma correction, white balance correction, YC conversion processing, electronic zoom processing, compression processing and decompression processing. The image processing section 130 may be designed to perform just some of these types of processing. Also, the image processing section 130 may be implemented as a hardwired electronic circuit or a microcomputer in which a program has been installed. Optionally, the image processing section 130 and the controller 150 may be implemented as a single semiconductor chip.

The buffer memory 140 functions as a work memory for either the image processing section 130 or the controller 150 and may be implemented as a DRAM, for example.

The flash memory 141 functions as an internal memory to store the image data and other kids of data.

The controller 150 is a control means for controlling the entire digital camera 100. For example, the controller 150 gets the image data that either will be processed, or has already been processed, by the image processing section 130 stored in the flash memory 141 or the memory card 161.

The controller 150 may be implemented as a hardwired electronic circuit or a microcomputer in which a program has been installed. Optionally, the controller 150 and the image processing section 130 may be implemented as a single semiconductor chip. Also, the controller 150 may include an internal memory.

The card slot 160 is designed so as to allow the user to insert or remove the memory card 161 into/from it. And the card slot 160 can be connected to the memory card 161 both electrically and mechanically alike. Optionally, the card slot 160 may have a function of controlling the memory card 161.

The memory card 161 is an external memory with a built-in storage device such as a flash memory, and can store the image data to be processed by the image processing section 130. In this preferred embodiment, the memory card 161 is illustrated as an external memory. However, this is just an example. Alternatively, a storage medium such as an optical disc may also be used as an external memory.

As its function as “external memory” signifies, the memory card 161 is removable from the digital camera 100 and does not have to be an essential component for the digital camera 100. In FIG. 1, however, the memory card 161 is illustrated as one of the components of the camera 100 for the sake of convenience.

The LCD monitor 170 is a device for presenting an image, represented by the image data to display that has been processed by the image processing section 130. Besides such an image, the LCD monitor 170 can also display settings of the digital camera 100, for example. In this preferred embodiment, an LCD monitor is supposed to be used as an exemplary display device. However, the present invention is in no way limited to this specific preferred embodiment. Alternatively, an original EL display, an inorganic EL display, a plasma display or a CRT could also be used.

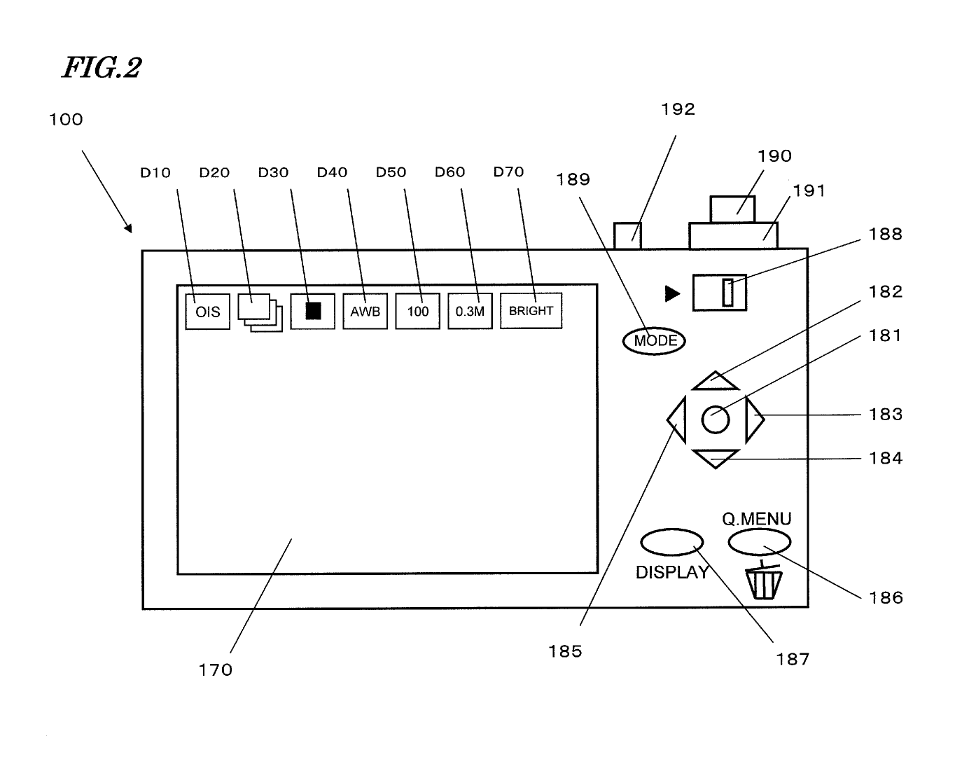

The interface section 180 is a generic term that refers to various buttons, keys and dials on this digital camera 100 collectively. For example, a shutter release button 190, cross keys 182 to 185, and a zoom dial 191 to be described later with reference to FIG. 2 may form the interface section 180. In accordance with the user's instruction that has been entered through the interface section 180, the controller 150 controls the digital camera 100 overall.

The interface section 180 is also used by the user to change the settings about various modes of operation of the digital camera 100. As used herein, the “settings about various modes of operation” include the ON/OFF states of various functions of the digital camera 100 and numerical settings to be cleared to perform a selected or entered function. By changing those settings, the user can determine, according to his or her preference, whether the optical image stabilizer function should be turned ON or OFF, whether the sequential shooting function should be turned ON or OFF, how big the data size of an image shot should be, and whether the white balance should be determined automatically or preset by him- or herself.

On the LCD monitor 170 of the digital camera 100, shown are a number of icons, which symbolize various available options that have been classified in advance with respect to respective modes of operation of the digital camera 100. In the following description, those options will be simply referred to herein as “operation mode options”. By choosing any of these icons through the interface section 180, the user can change the settings of the operation mode option that is symbolized by that icon. As for specific examples of such operation mode options and exactly how to change those settings, see the detailed description to be provided later.

FIG. 2 is a rear view of the digital camera 100. The interface section 180 is arranged on the rear and top surfaces of the digital camera 100. On the rear side of the digital camera 100, also arranged is the LCD monitor 170.

The ENTER button 181 is used for the user to determine his or her selection of a setting that is offered as a candidate on the LCD monitor 170. For example, if the user presses down the ENTER button 181 while one of candidate settings of a certain operation mode option is selected with a cursor (or highlighted) on the LCD monitor 170, then the controller 150 adopts that candidate as the final setting. Optionally, a dialog box for detailed settings can also be displayed on the LCD monitor 170 by pressing down the ENTER button 181. On that dialog box for detailed settings, the settings of an operation mode option that can be exercised with a quick menu to be described later are determined.

The UP, RIGHT, DOWN and LEFT keys 182, 183, 184 and 185 together form cross keys. For example, if the user presses down the UP key 182, the controller 150 changes the cursor locations upward on the LCD monitor 170. Likewise, the RIGHT, DOWN and LEFT keys 183, 184 and 185 are used to move the cursor rightward, downward and leftward, respectively.

The DELETE button 186 is used to delete image data from the flash memory 141 or the memory card 161. Also, if the controller 150 is operating in a shooting mode, the DELETE button 186 is used to display a quick shooting menu (which will be referred to herein as a “quick menu”) on the LCD monitor 170.

In FIG. 2, a “quick menu” according to this preferred embodiment is displayed on the LCD monitor 170. More specifically, the “quick menu” is represented by the icons D10 through D70 that are shown at the top of the screen of the LCD monitor 170. These icons D10 through D70 symbolize respective operation mode options.

The operation mode options, of which the settings can be determined with this quick menu, are just a part of various options that can be called (or displayed) by pressing down the ENTER button 181. By allowing the user to determine the settings of those operation mode options with such a quick menu, the settings can be changed very easily. As some of those operation mode options need to have their settings changed frequently, the handiness of the digital camera 100 can be increased by introducing such a quick menu.

Hereinafter, it will be described exactly how to change the settings of those operation mode options using the quick menu.

The icons D10 through D70 symbolize respective operation mode options. And each of these icons represents the current setting of its operation mode option (such as whether the function is now ON or OFF or a minimum required level to perform that function). Hereinafter, it will be described one by one what these icons mean.

The icon D10 is provided to allow the user to determine the setting of an operation mode option about an optical image stabilizer function, which may include a mode in which the optical image stabilizer function is always ON during a shooting operation, a mode in which the optical image stabilizer function is activated only during an exposure operation, and a mode in which the optical image stabilizer function is turned OFF. And the user may exercise any one of these three options.

The icon D20 is provided to allow the user to determine the setting of an operation mode option about a sequential shooting function, which may include a 3 frames sequential shooting mode in which three images are shot back to back every time the shutter release button 190 is pressed down fully, an unlimited (or free) sequential shooting mode in which an unlimited number of photos are shot sequentially as long as the shutter release button 190 is pressed down fully, and a mode in which the sequential shooting function is turned OFF. And the user may exercise any one of these three options.

The icon D30 is provided to allow the user to determine the setting of an operation mode option about focus framing during an autofocus operation. The focus framing may include a mode in which the focus is fixed only at the central frame and a mode in which at least one of sixteen frames is automatically adopted according to the composition of the image to be shot. And the user may exercise any one of these multiple options.

The icon D40 is provided to allow the user to determine the setting of an operation mode option about a white balance, which may include an automatic white balance mode, a sunny mode and a cloudy mode.

The icon D50 is provided to allow the user to determine the setting of an operation mode option about an ISO sensitivity, which may include an automatic ISO sensitivity, an ISO100 sensitivity, and an ISO200 sensitivity.

The icon D60 is provided to allow the user to determine the setting of an operation mode option about the number of recording pixels, which may be ten million pixels or three million pixels, for example.

The icon D70 is provided to allow the user to determine the setting of an operation mode option about the brightness of the LCD monitor 170, which may be “bright”, “moderate” or “dark”, for example.

A DISPLAY button 187 is used to change the modes of display on the LCD monitor 170. That is to say, when the DISPLAY button 187 is pressed down, the controller 150 may start or stop displaying a guideline on the screen of the LCD monitor 170.

An operation mode switch 188 is a slide switch. That is to say, by sliding the operation mode switch 188 to the right, the modes of operation of the controller 150 can be changed into “shooting”. On the other hand, if the operation mode switch 188 is slid to the left, then the modes of operation of the controller 150 can be changed into “playback”.

An operation mode button 189 is used to allow the user to determine a specific mode of operation. That is to say, by pressing down the operation mode button 189, the user can select any mode of operation he or she likes.

For example, if the operation mode button 189 is pressed down while the current setting of the operation mode is “shooting”, then options including “normal shooting”, “macro shooting” and “twilight shooting” will be offered. In response, the user may select one of those options by tapping the cross keys 182 to 185 and then determine his or her selection by pressing down the ENTER button 181. Then, the controller 150 will control the digital camera 100 in the shooting mode selected.

On the other hand, if the operation mode button 189 is pressed down while the current setting of the operation mode is “playback”, then options including “normal playback” and “slide show” will be offered. In response, the user may select one of those options by tapping the cross keys 182 to 185 and then determine his or her selection by pressing down the ENTER button 181. Then, the controller 150 will control the digital camera 100 in the playback mode selected.

The shutter release button 190 is used to start capturing a still picture. The zoom dial 191 is used to change the zoom powers during shooting. And the power switch 192 is a slide switch for turning ON or OFF the digital camera 100.

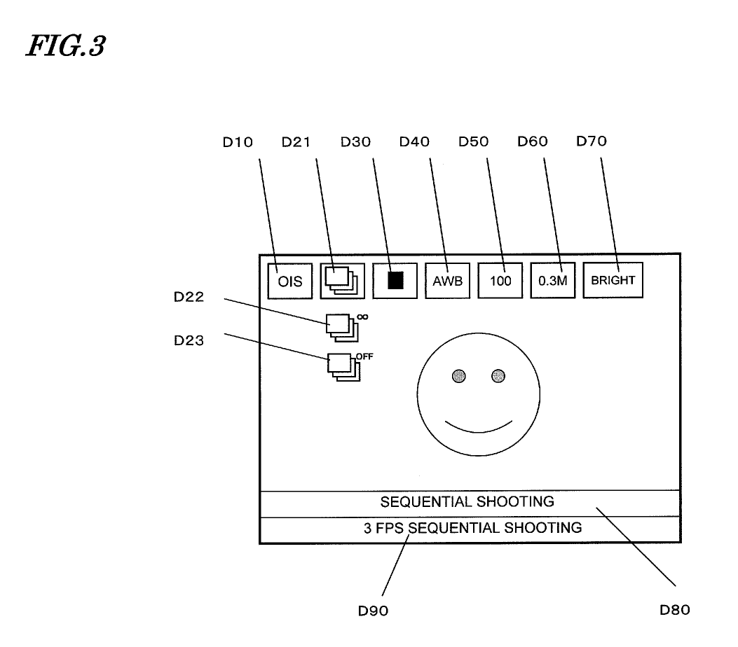

Hereinafter, it will be described with reference to FIGS. 3 to 5 how this digital camera 100 operates when the settings of an operation mode option are changed using the quick menu.

FIG. 3 illustrates what is presented on the LCD monitor 170 when the RIGHT key 183 is pressed down after the quick menu has been called up onto the screen under the control of the controller 150. In the situation illustrated in FIG. 3, the icon D21 is highlighted, thus allowing the user to determine the setting of the sequential shooting function of the digital camera 100. In this preferred embodiment, when the DELETE button 186 is pressed down, the quick menu is supposed to be called up, and the icon D10 for determining the setting of the optical image stabilizer function is supposed to be highlighted at that point in time. That is to say, the icon D10 is supposed to be chosen by default unless the interface section 180 is manipulated by the user.

As used herein, the “highlighted” state refers to the special appearance of a certain icon chosen to tell it from the other non-chosen icons. In this preferred embodiment, the “highlighted” state is supposed to refer to a situation where an icon is surrounded with a flickering cursor, for example.

In the example illustrated in FIG. 3, a subject is now presented at the center of the screen. The quick menu, including the icons, is preferably superimposed on the through image (or through-the-lens image) being captured. This is because the user can continue capturing his or her subject, and is not interfered with in his or her shooting, before and after the quick menu is called up.

If the RIGHT key 183 or the LEFT key 185 is pressed down in such a state, then the controller 150 moves the cursor that surrounds the current icon, thereby entering the user's choice of the icon symbolizing the operation mode option, of which the settings have been changeable until the cursor is moved. That is to say, once the RIGHT key 183 or the LEFT key 185 is pressed down, the change of the settings of the previous operation mode option (that have been changeable before the cursor is moved) is no longer accepted (or supposed to be done) but the user's instruction to change the settings of any other operation mode option is accepted.

Also, as for an operation mode option, of which the settings are currently changeable, multiple icons symbolizing available options are shown at the same time. As for an operation mode option, of which the settings are no longer changeable, on the other hand, only an icon symbolizing the currently exercised option is shown.

In the example illustrated in FIG. 3, the sequential shooting option symbolized by the icon D21 is supposed to be an exercised option that should have its settings changed. In this preferred embodiment, to provide available options, not only the icon D21 symbolizing the currently exercised option (i.e., 3 fps sequential shooting) but also icons symbolizing other options with changeable settings are shown at the same time. Specifically, an icon D22 symbolizing “unlimited sequential shooting” and an icon D23 symbolizing “sequential shooting OFF” are also shown.

Nevertheless, until the UP key 182 or the down key 184 is pressed down, the icon D20 symbolizing the currently exercised operation mode option “3 fps sequential shooting” is surrounded with the cursor. Thus, the user can see easily what option is currently exercised.

In the situation illustrated in FIG. 3, the settings of operation mode options symbolized by the icons D10, D30 etc. other than the icon D20 are now non-changeable. As for such operation mode options, only those icons symbolizing the currently exercised options are displayed.

Next, the pieces of information displayed at the bottom of FIG. 3 will be described.

FIG. 3 shows an option information display field D80 and a setting information display field D90.

In the option information display field D80, displayed is information about the currently exercised operation mode option, of which the settings are now changeable. In the example illustrated in FIG. 3, the option information display field D80 indicates that an operation mode option about the sequential shooting function symbolized by the currently chosen icon D21 can have its settings changed. By providing the option information display field D80 on the LCD monitor 170, the user can see easily what operation mode option may have its settings changed now.

On the other hand, the setting information display field D90 displays information about the presently adopted one of the multiple candidate settings of the currently changeable operation mode option. By providing such a setting information display field D90 on the LCD monitor 170, the user can easily see exactly what setting is now adopted for that operation mode option.

In the example illustrated in FIG. 3, as the operation mode option D21 about the sequential shooting function can now have its settings changed, a piece of information “sequential shooting” representing that operation mode option is displayed in the option information display field D80. Also, as “3 fps sequential shooting” is presently adopted for the operation mode option about sequential shooting, a piece of information “3 fps sequential shooting” is now displayed in the setting information display field D90.

If the RIGHT key 183 or the LEFT key 185 is pressed down, then the controller 150 makes the settings of a different operation mode option, other than the option of which the settings have been changeable until then, changeable and indicates that in the option information display field D80. For example, if the LEFT key 185 is pressed down, the icon D10 symbolizing the optical image stabilizer function is chosen and its settings now become changeable.

Any kind of information may be displayed in the option information display field D80 as long as that information indicates what operation mode option can now have its settings changed. For example, that information may be the name of the function itself and/or a more detailed description of that function. Specifically, a description such as “multiple photos can be shot sequentially by pressing down the shutter release button only once” may be displayed either instead of, or in addition to, the function name “sequential shooting”. Likewise, any kind of information may be displayed in the setting information display field D90 as long as that information indicates what setting is presently adopted.

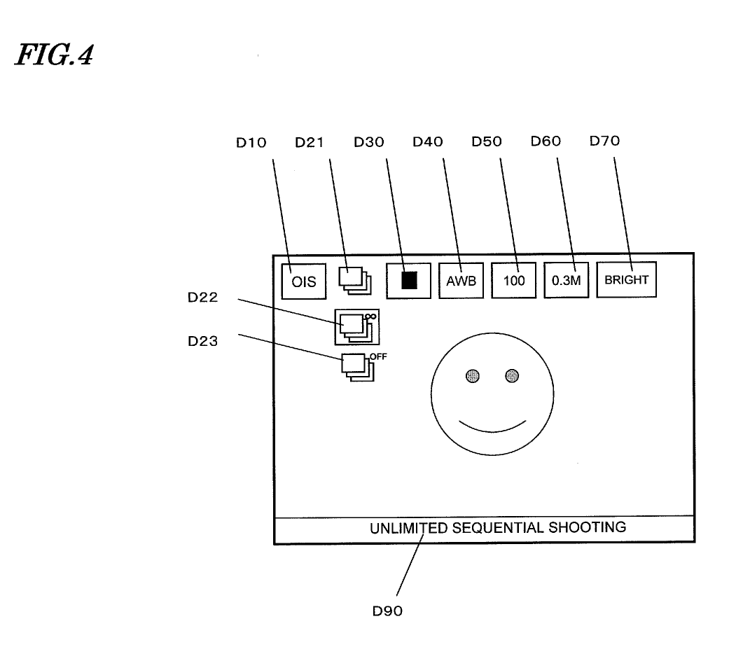

Next, it will be described with reference to FIG. 4 how to adopt a new setting after the operation mode option has gotten ready to change its settings.

If the UP key 182 or the DOWN key 184 is pressed down in the state shown in FIG. 3, an icon representing a different setting is chosen with respect to the operation mode option with currently changeable settings. Specifically, although the icon D21 symbolizing “3 fps sequential shooting” is chosen in FIG. 3, the icon D22 symbolizing “unlimited sequential shooting” is now chosen in FIG. 4 because the UP key 182 has been pressed down twice in a row or the DOWN key 184 has been pressed down once.

Next, if the user ends the display of the quick menu or makes the settings of another operation mode option changeable by tapping the RIGHT key 183 or the LEFT key 185, then the controller 150 adopts the setting represented by the icon that has been chosen with respect to the previous operation mode option that has been exercised until the key 183 or 185 is pressed.

And if the UP key 182 or the DOWN key 184 is pressed down, an icon symbolizing another operation mode option is chosen and the controller 150 updates the setting information display field D90, thereby getting information about that setting displayed on the LCD monitor 170. The controller 150 also controls the display operation of the LCD monitor 170 so that the option information display field D80, displayed in FIG. 3, is no longer shown. Specifically, the controller 150 generates a video signal that represents a quick menu image including video information in which the information in the setting information display field D90 has been updated but not including the video information in the option information display field D80 and outputs the video signal to the LCD monitor 170.

In the example illustrated in FIG. 4, the icon D22 symbolizing the unlimited sequential shooting function is surrounded with the cursor, “free sequential shooting”, which is a piece of information about its setting, is displayed in the setting information display field D90, and the option information display field D80 that said “sequential shooting” is no longer displayed.

As described above, if the user presses down either the RIGHT key 183 or the LEFT key 185, the controller 150 gets the settings of a different operation mode option, other than the option of which the settings have been changeable, ready to change, thereby getting the option information display field D80 displayed. On the other hand, if the user presses down either the UP key 182 or the right key 183 after that, the controller 150 controls the display operation of the LCD monitor 170 so as to stop showing the option information display field D80.

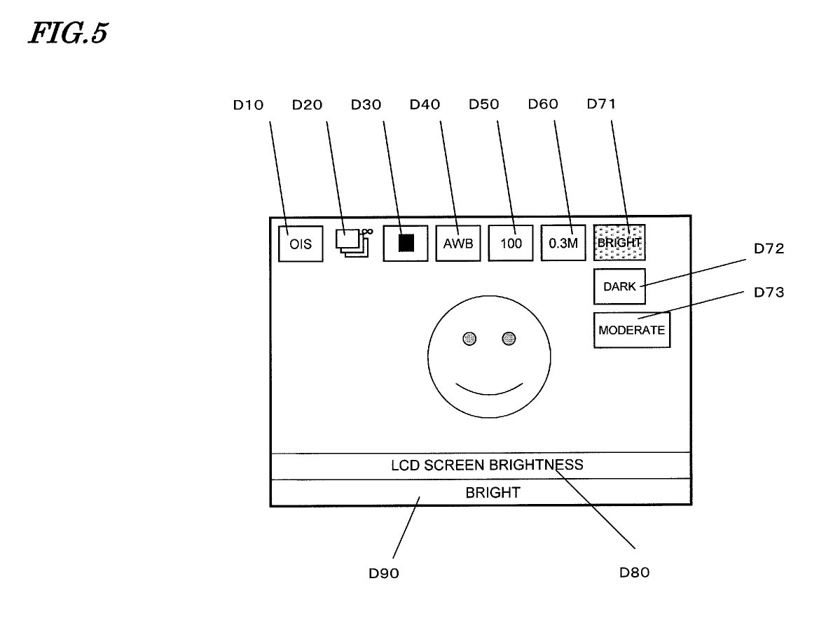

FIG. 5 illustrates an exemplary quick menu image to be displayed in a situation where the settings of an operation mode option called “LCD screen brightness” are ready to change in response to the pressure on the RIGHT key 183 or the LEFT key 185.

By pressing either the UP key 182 or the DOWN key 184 in such a state, the user can change the settings of the “LCD screen brightness”. More specifically, if the UP key 182 or the DOWN key 184 is pressed down in the state shown in FIG. 5, the controller 150 moves the cursor to an icon representing a different setting and updates the information displayed in the setting information display field D90 into information about the newly adopted setting. Subsequently, the controller 150 controls the display operation of the LCD monitor 170 so as to stop showing the option information display field D80. And the controller 150 further controls the display operation of the LCD monitor 170 so that the LCD monitor 170 operates with the newly adopted setting (i.e., at a modified brightness).

For example, if the DOWN key 184 is pressed down when the setting “bright” is presently adopted as shown in FIG. 5, then the controller 150 moves the cursor to the icon “dark”, updates the information in the setting information display field D90 into “dark”, and decreases the brightness of the LCD monitor 170 by a predetermined degree. Then, the image on the LCD monitor 170 will darken. In this manner, since a newly adopted setting is immediately reflected on the operation, the user can see quickly and easily whether the newly adopted setting is good or bad.

Examples of such operation mode options, of which the newly adopted setting is quickly reflected on the operation, include not just “LCD screen brightness” but also “white balance”.

As described above, the digital camera 100 of this preferred embodiment can have its settings changed in terms of multiple operation mode options and can control its own operation according to the setting adopted.

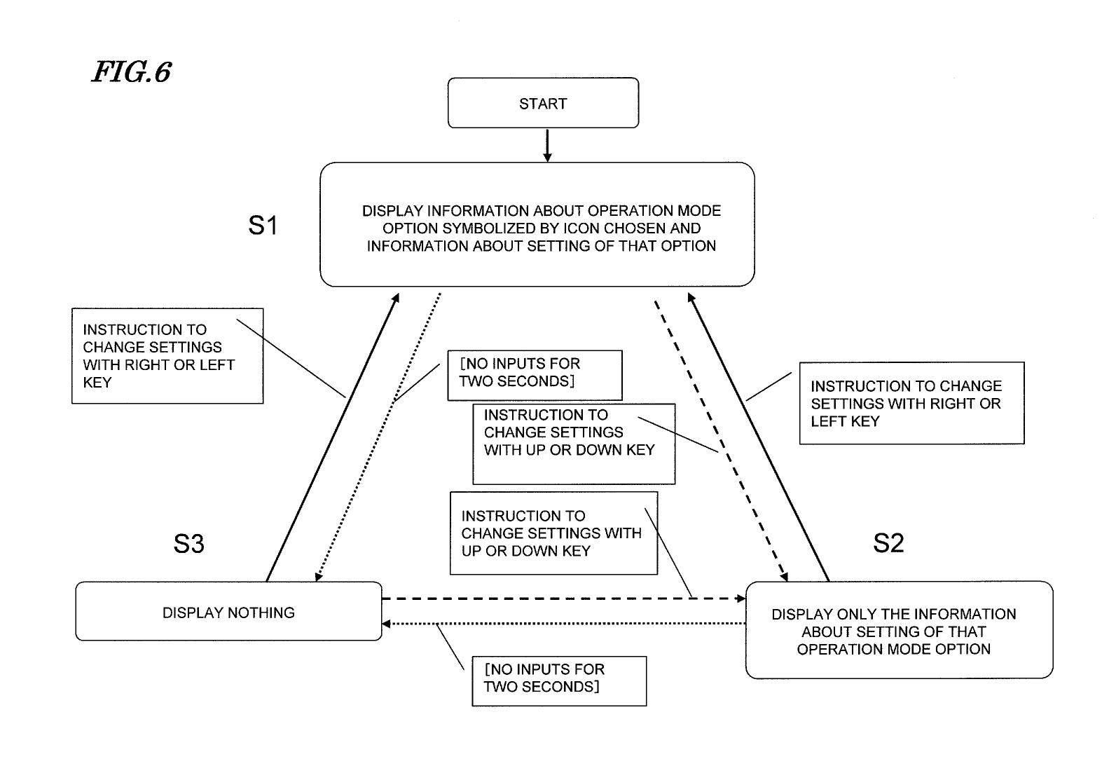

FIG. 6 is a state transition diagram illustrating how this digital camera 100 operates. That is to say, if the controller 150 controls the operation of the digital camera 100 so that the digital camera 100 makes the state transitions shown in FIG. 6, the digital camera 100 can operate just as described above.

The processing starts when the quick menu is called up in response to the pressure on the DELETE button 186.

First, in State S1, the controller 150 of the digital camera 100 displays not only information about an operation mode option symbolized by the chosen icon in the option information display field D80 of the LCD monitor 170 but also information about the settings of that operation mode option in the setting information display field D90 at the same time.

Thereafter, when the settings of the operation mode option are changed by pressing down either the UP key 182 or the DOWN key 184, transition to the state S2 is made. In that State S2, the controller 150 displays information about the setting adopted for the operation mode option in the setting information display field D90 of the LCD monitor 170. At this point in time, the controller 150 stops showing the option information display field D80.

When a predetermined amount of time (of two seconds, for example) passes in State S1 with no instructions received from the user, transition will be made from State S1 to State S3, in which the controller 150 stops showing both the option information display field D80 and the setting information display field D90.

Meanwhile, if the user changes the operation mode options in State S2 by pressing down either the LEFT key 185 or the RIGHT key 183, then transition to State S1 is made.

However, when a predetermined amount of time (of two seconds, for example) passes in State S2 with no instructions received from the user, the controller 150 will stop showing the setting information display field D90.

If the settings of the operation mode option are changed in State S3 by pressing down either the LEFT key 185 or the RIGHT key 183, transition to the state S1 is made. On the other hand, if the settings of the operation mode option are changed in State S3 by pressing down either the UP key 182 or the DOWN key 184, then transition to the state S2 is made.

While the quick menu is displayed, transitions are made between these States S1, S2 and S3. And when the quick menu stops being displayed, the processing will end.

The digital camera 100 includes the LCD monitor 170, the RIGHT, LEFT, UP and DOWN keys 183, 185, 182 and 184 and the controller 150. The LCD monitor 170 shows icons representing changeable settings. The RIGHT and LEFT keys 183 and 185 are used to accept a user's instruction to make the settings of an operation mode option, which are now changeable, no longer changeable and to make the settings of other operation mode options changeable. On the other hand, the UP and DOWN keys 182 and 184 are used to accept a user's instruction to change from a state in which an icon representing any of multiple settings available is chosen into a state in which an icon representing another setting is chosen with respect to an operation mode option, of which the settings are now changeable. And if either the RIGHT key 183 or the LEFT key 185 is pressed down, the controller 150 makes changeable the settings of a different operation mode option, other than the option of which the settings have been changeable, and displays information about the operation mode option, of which the settings are now changeable, in the option information display field D80. Meanwhile, if either the UP key 182 or the DOWN key 184 is pressed down, then the controller 150 controls the display operation of the LCD monitor 170 so as to stop showing the option information display field D80.

Since the option information display field D80 is shown, the user can easily see exactly what operation mode option may have its setting changed. Then, even a user who cannot see what an icon means by itself can also understand more easily exactly what can be changed now. Thus, the present invention provides a more user-friendly digital camera. Meanwhile, since the option information display field D80 is no longer shown when the settings of an operation mode option are changed, the dialog box (i.e., the quick menu) can be simplified and the user is less likely to make mistakes in operating this camera. As a result, this digital camera 100 realizes increased handiness. What is more, as the user knows on what operation mode option he or she is going to change the settings by looking at the option information display field D80, there is no problem even if the option information display field D80 disappears after that. By eliminating the option information display field D80, it is possible to prevent the layout of the dialog box from getting too complicated, thus realizing an increased degree of handiness for the user.

Also, as in the preferred embodiment described above, the controller 150 may control the display operation of the LCD monitor 170 so as to always show the setting information display field D90 that provides information about the setting represented by a currently chosen icon. Then, the user can see easily what setting is now adopted.

Furthermore, as in the preferred embodiment described above, the controller 150 may also instruct the LCD monitor 170 to show multiple icons, representing available settings, at the same time for an operation mode option, of which the settings are currently changeable. Then, the user can easily see exactly what settings are available now.

Furthermore, the controller 150 controls the display operation of the LCD monitor 170 so as to show multiple icons representing available settings at the same time for an operation mode option, of which the settings are currently changeable, and show only an icon representing the presently adopted setting for an operation mode option, of which the settings are currently not changeable. Then, as the layout of the dialog box can be simplified, the present invention realizes an increased degree of handiness, and therefore, the user is much less likely to commit an error in handling this digital camera.

It should be noted, however, that the digital camera described above is just a preferred embodiment of the present invention. Rather, the present invention is applicable for use in any other electronic device if its settings are changeable for a number of operation mode options and if the device controls itself based on the settings adopted.

In the preferred embodiments described above, the RIGHT and LEFT keys 183 and 185 of the cross keys are supposed to be used as a specific interface section 180 for choosing an icon symbolizing a desired operation mode option. However, the user may also change the settings by manipulating a joystick, a speech recognition device, a line-of-sight vector estimation system, or a touchscreen panel, for example. That is to say, any interface section may be used as long as the interface section can accept a user's instruction to make the settings of an operation mode option, which are currently changeable, unchangeable and to make the settings of other options changeable.

Furthermore, in the preferred embodiment described above, the UP and DOWN keys 182 and 184 of the cross keys are supposed to be used as a specific interface section 180 for changing the settings of an operation mode option symbolized by an icon chosen. However, the user may also change the settings by manipulating a joystick, a speech recognition device, a line-of-sight vector estimation system, or a touchscreen panel, for example. That is to say, any interface section may be used as long as the interface section can accept a user's instruction to change from a state in which an icon representing any of multiple settings available is chosen into a state in which an icon representing another setting is chosen with respect to an operation mode option, of which the settings are now changeable.

Furthermore, in the preferred embodiment described above, at least two icons representing multiple settings available are supposed to be shown at the same time for an operation mode option, of which the settings are currently changeable. However, only an icon representing a presently adopted setting may be shown instead because the layout of the dialog box can be simplified then. Nevertheless, in order to increase the handiness for the user, it is still preferable that multiple icons representing available settings be displayed at the same time for an operation mode option, of which the settings are currently changeable.

Furthermore, in the preferred embodiment described above, only an icon representing a presently adopted setting is supposed to be shown for an operation mode option, of which the settings are currently unchangeable. However, multiple icons representing available settings may also be displayed at the same time even for a non-exercised operation mode option, of which the settings are currently unchangeable.

In an electronic device according to the present invention, if an instruction to change the settings of a currently exercised option is entered through the interface section, general information about that option itself is no longer displayed. As a result of this processing, an area for displaying other kinds of information to be provided can be left, and therefore, such a technique is very effectively applicable to especially electronic devices with a narrow display area. However, the same effect can also be achieved even in an electronic device with a broad display area. For example, in a situation where icons and other kinds of information need to be displayed in as large a size as possible for senior people, the broader the display area left, the more easily they can see the icons and the handier this digital camera can be.

In the preferred embodiments described above, the present invention has been described as being applied to a digital camera 100 with an LCD monitor 170. However, the present invention is also applicable for use in even a device with no display device equivalent to the LCD monitor. In that case, a control section corresponding to the controller 150 of the preferred embodiment described above may generate a video signal and send it to an external display device, which may show multiple icons symbolizing respective options in response to the video signal and may provide information about the option symbolized by the icon chosen.

### INDUSTRIAL APPLICABILITY

The present invention is applicable to any electronic device if the device at least allows the user to change the settings of multiple options and if the device controls itself based on the settings adopted. For example, the present invention is applicable to cellphones, portable audio players/recorders, and car navigation systems.

1. An electronic device designed to operate adaptively according to a combination of settings of a plurality of options that are offered in order to allow the user to select his or her desired mode of operation, the device comprising:
an interface section to be manipulated by the user to change the settings;
a display section operable to show a number of icons symbolizing the plurality of options and information about a currently exercised option represented by a chosen one of the icons; and
a control section configured to control the display operation of the display section such that if the user has entered an instruction to change a setting of the currently exercised option through the interface section, information about the currently exercised option stops being displayed.

2. The electronic device of claim 1, wherein the display section displays the information about the currently exercised option and information about a setting that is presently adopted with respect to the currently exercised option until the instruction to change the settings of the currently exercised option is entered through the interface section.

3. The electronic device of claim 2, wherein the display section shows an icon representing each of a plurality of settings available with respect to the currently exercised option, and
wherein when the instruction to change the settings of the currently exercised option is entered through the interface section, the control section changes what is presented on the display section so that information about a newly adopted setting represented by the icon now chosen is provided.

4. The electronic device of claim 3, wherein the display section shows a plurality of icons, representing the plurality of settings available with respect to the currently exercised option, at the same time.

5. The electronic device of claim 1, wherein as for any of the options, of which the settings are currently unchangeable, the display section shows an icon, representing a setting that is presently adopted, with respect to that option.

6. The electronic device of claim 3 wherein the display section provides a brief description of a function of the electronic device as information about the currently exercised option, and indicates, as information about the presently adopted setting, whether the function is now ON or OFF and/or a required minimum level to perform the function.

7. The electronic device of claim 1, wherein the interface section accepts an instruction to change the settings of the currently exercised option and an instruction to choose one of the icons symbolizing the plurality of options that have been entered in mutually different ways.
